(19) United States
(12) Patent Application Publication
(10) Pub. No.: US 2003/0046335 A1
(43) Pub. Date: Mar. 6, 2003

(54) Efficiently serving large objects in a distributed computing network

(75) Inventors: Ronald P. Doyle, Raleigh, NC (US); David L. Kaminsky, Chapel Hill, NC (US); David M. Ogle, Cary, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 09/943,562

(22) Filed: Aug. 30, 2001

(51) Int. Cl. G06F 15/16

(52) U.S. Cl. 709/203; 709/232

(57) ABSTRACT

Techniques are disclosed for improving the serving of large objects (equivalently, large files) in distributed computing networks which include network-attached storage (“NAS”). Existing features of Hypertext Transfer Protocol (“HTTP”) and of Web server implementations are leveraged to achieve performance improvements in a novel way, and thereby greatly facilitate introduction of the present invention into existing networking environments. In particular, objects meeting certain criteria may be served using “redirect files” in which a redirect status code is used to cause content retrieval requests to be automatically redirected from the requesting client device to the NAS, such that the requested content is served from the NAS rather than through a Web server from a Web server farm.

### BACKGROUND OF THE INVENTION

1. Field of the Invention

The present invention relates to distributed computing networks, and deals more particularly with improved techniques for serving large objects to requesters in such networks.

2. Description of the Related Art

The popularity of distributed computing networks and network computing has increased tremendously in recent years, due in large part to growing business and consumer use of the public Internet and the subset thereof known as the “World Wide Web” (or simply “Web”). Other types of distributed computing networks, such as corporate intranets and extranets, are also increasingly popular. As solutions providers focus on delivering improved Web-based computing, many of the solutions which are developed are adaptable to other distributed computing environments. Thus, references herein to the Internet and Web are for purposes of illustration and not of limitation.

Some types of simple Web content result in delivery of relatively small objects (or, equivalently, files in which those objects are stored), while other types of content can be quite large. In the latter case, examples include sound files, image files, streaming audio, streaming video, and various other types of multi-media content.

While some content requests are generated programmatically, many content requests have a human user waiting for a response. Returning responses quickly and efficiently can therefore be critical to user satisfaction and to the overall success of a Web site. An additional concern in a distributed computing environment is the processing load on the computing resources. If a bottleneck occurs, overall system throughput may be seriously degraded. To address this situation, the content supplier may have to purchase additional servers, which increases the cost of doing business. Furthermore, for content types that have a time-sensitive aspect, such as streaming audio and streaming video, processing inefficiencies and network delays must be avoided to the greatest extent possible.

FIG. 1 provides a diagram of a representative server site 100 in which a content request is serviced. (The term “server site” as used herein refers to a collection of server nodes that serve Web content associated with a given fully-qualified domain name. For example, the server site 100 in FIG. 1 may, for purposes of example, serve content for a domain name such as “www.ibm.com”.) In this example, a content request 110 is transmitted from a client (not shown) through a network such as the Internet 120 and then to a load balancing host 130 (that is, a computing device which distributes incoming requests across a plurality of Web servers 140 to balance the processing load). The load balancing host 130 may then select one of the Web servers 140 (such as Apache, Netscape, or Microsoft servers), according to the load balancing strategy which has been implemented in host 130. To serve the requested content, a particular Web server may invoke the services of an application server (such as a WebSphere® application server which is available from the International Business Machines Corporation, or “IBM”), where this application server may be co-located with the Web server 140 in a single hardware box or may be located at a different device 150. The Web server may also or alternatively invoke the services of a back-end enterprise data server 160 (such as an IBM OS/390® server running the DB/2, CICS®, and/or MQI products from IBM), which may in turn access one or more databases 170 or other data repositories. (“WebSphere”, “OS/390”, and “CICS” are registered trademarks of IBM.)

The load balancing host 130 may also function as a surrogate (reverse proxy cache) or 20 forward proxy cache (and these terms, or the term “cache server”, are used interchangeably herein). The IBM WebSphere Edge Server is one implementation which provides this combined functionality. For example, it may be possible in some cases to serve the requested content from cache storage which is accessible to host 130, rather than sending the content request on to a Web server 140. Or, a cache server might be located elsewhere in the network path between the content requester and the Web server(s). For example, a cache server might be encountered before a content request 110 reaches a load balancing host 130.

A technique that goes a long way toward improving performance in a distributed computing environment is to combine (1) caching to reduce the number of requests that reaches the Web servers, thereby improving response time and reducing processing load, and (2) workload balancing to attempt evenly distributing content requests among a cluster of Web servers. However, in many cases, there is room for improvement. Content might not be cached if it is too large. There may also be some situations in which caching is ineffective. For example, content might be specified as not cachable for one reason or another. Or, there might be dynamically-generated elements in popular content which effectively prevents its being served from cache. When content cannot be served from cache, the content requests come to a Web server—which, in many cases, subsequently routes the content requests to network-attached storage (“NAS”) or a NAS system.

NAS systems may be thought of as servers which are dedicated to file storage and retrieval, and typically use a combination of hardware and software to service file requests. The hardware generally comprises persistent storage devices such as disk drives (and in particular, high-volume storage devices such as “redundant array of independent disk” or “RAID” devices) which store the file content. Typically, the NAS is given its own network address, and the NAS system's software is responsible for determining the mapping between a particular network address from an incoming content request and a corresponding location on a storage device where content is to be stored in the case of a storage request, or where content resides which can be used in serving a content retrieval request.

NAS systems are gaining popularity in the marketplace because they can provide a low-cost storage solution with excellent performance characteristics. They provide flexibility by allowing companies to add storage simply by connecting large storage components to the network. NAS systems also improve operations in distributed computing networks by enhancing availability and by offloading file storage and retrieval operations from Web servers, enabling the Web servers to scale more easily (that is, to effectively handle a higher volume of content requests). FIG. 2 illustrates a typical configuration wherein a distributed computing network 200 includes NAS (shown generally as NAS system 250). Client computers access the NAS system 250 through a standard network 220, such as a standard Internet Protocol—or “IP”—based intranet, extranet, or the public Internet. The NAS system 250 is depicted in FIG. 2 as comprising a controller function or control unit 230 and several storage devices or storage subsystems 240, such as IBM's Enterprise Storage Server product, which is a commercially-available high-capacity enterprise storage system. The NAS controller function 230 (which may be comprised of hardware and/or software elements) connects both to the network 220 and to the storage devices 240. Connection between a NAS controller function 230 and a storage device 240 can be made using a standard storage access protocol, such as Fibre Channel, ESCON®, or SCSI. (“ESCON” is an abbreviation for “Enterprise Systems Connection”, and is a registered trademark of IBM. “SCSI” is an abbreviation for “Small Computer System Interface”. The details of FibreChannel, ESCON, and SCSI are not deemed necessary for an understanding of the present invention, and thus these technologies will not be described in detail herein.) The storage device(s) 240 can be integrated with the NAS controller function 230 and packaged as a whole to form a NAS system 250, or the NAS controller function 230 and the storage device(s) 240 can be separate. In the latter case, a NAS controller function 230 is often called a “gateway”, as it provides a gateway to the storage device(s). (References hereinafter to use of NAS systems are intended to include integrated NAS systems as well as NAS gateway implementations.)

A NAS system typically exports (i.e. supports) one or more file-access protocols such as NFS, WebNFS, and CIFS. “NFS” is an abbreviation for “Network File System”. “CIFS” is an abbreviation for “Common Internet File System”. NFS was developed by Sun Microsystems, Inc. “WebNFS” is designed to extend NFS for use in the Internet, and was also developed by Sun Microsystems. CIFS is published as X/Open CAE Specification C209, copies of which are available from X/Open. These protocols are designed to enable a client to access remotely-stored files (or, equivalently, stored objects) as if the files were stored locally. When these protocols are used in a NAS system, the NAS controller function 230 is responsible for mapping requests which use the protocols into requests to actual storage, as discussed above. (Details of these file access protocols are not deemed necessary to an understanding of the present invention, and will not be described in detail herein.)

A FIG. 3 illustrates, most NAS systems 350 use a simple Web server 330 (which is embedded in, or otherwise included in, NAS system 350) to allow configuration of the NAS system. Using a standard Web browser client 310 to access the configuration subsystem 340 of the NAS, administrators can configure NAS device settings, such as giving users file-access permissions. This approach for configuring a NAS system is also commonly used in a wide variety of software products.

FIG. 4 illustrates, at a high level, components of a NAS system 400. Requests arrive at the NAS system using any of the exported protocols. For purposes of illustration, the exported protocols are shown in FIG. 4 as including HTTP 410 (which may be used for configuration requests, as discussed above), CIFS 430, and NFS 450. The requests are received by a corresponding protocol handler component 420, 440, 460, and are passed to the NAS's internal file system 470. One example of this internal file system is the General Parallel File System, or “GPFS”. (See IBM publication “IBM GPFS for AIX: Guide and Reference (SA22-7452)” for more information on GPFS.) The internal file system manages the blocks exported by the storage system from storage 480. Stored content is thus made available to the requesting protocol handler, which formats the proper response message and returns the content to the requester.

One strategy for serving large volumes of data in the prior art is to connect a NAS system to a network that also contains a cluster of Web servers. A cluster of Web servers is also commonly referred to as a “server farm”. As Web servers in the farm receive content retrieval requests, they simply access the NAS system to supply the requested content. This configuration is illustrated in FIG. 5 (see element 500). Note that while this figure shows the NAS system 550 and Web servers 540 connected to a private network 530 that is logically distinct from a public network 520, only one network is necessary—that is, all data passing between clients 510 and NAS system 550 can flow through a single network. In many cases, however, the public network 520 is the Internet and the private network 530 is a local area network or “LAN”. (Components such as load balancing hosts and firewalls have been omitted from FIG. 5 for clarity.)

When serving requests using this technique, the flow of data among components occurs generally as illustrated in FIG. 6. Requests from client 510 are sent 605 to a Web server 540, typically using the Hypertext Transfer Protocol, commonly referred to as “HTTP”. The Web server 540 forwards 615 the request to the NAS 550, typically using a file access protocol such as NFS or WebNFS. The NAS then accesses 625 the appropriate storage device for the requested file, and retrieves 635 the contents of that file. The NAS then sends 645 this file to the Web server as a response to message 615, and the Web server similarly sends 655 the file as a response to request message 605. (Components such as load balancing hosts and firewalls have been omitted from FIG. 6 for clarity.)

For relatively small files, the network path illustrated in FIG. 6 is typically the optimal way to serve files. However, for larger files, sending the data content through the Web server introduces a significant amount of network traffic and processing load for the Web server.

What is needed are improved techniques for serving large files in distributed computing networks.

### SUMMARY OF THE INVENTION

An object of the present invention is to provide improved techniques for serving large files in distributed computing networks.

Another object of the present invention is to increase efficiency of Web servers in distributed computing networks.

Yet another object of the present invention is to enable Web servers to handle higher volumes of traffic in a distributed computing network, thereby allowing the network to scale more easily.

Still another object of the present invention is to optimize delivery of large files in distributed computing networks which include network-attached storage.

A further object of the present invention is to enable improvements in serving large files in distributed computing networks without requiring introduction of specialized software.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for efficiently serving large objects in distributed computing networks. In one aspect of the present invention, this technique for efficiently serving objects comprises: receiving a request for an object stored on network-attached storage; and evaluating predetermined criteria to see if the stored object should be served from the NAS through a recipient of the received request. The evaluation preferably further comprises serving the stored object through the recipient of the received request when the selected criteria are not met, and informing a sender of the received request that a subsequent connection should be established for serving the stored object otherwise. Preferably, informing the sender comprises using a redirect code of an existing protocol (including, by way of example, HTTP or Wireless Session Protocol), and receipt of the redirect code by the sender of the received request automatically causes the sender to establish the subsequent connection, thereby bypassing the recipient of the received request for delivery of the object.

In this and other aspects, the predetermined criteria may include a size of the stored object ; a naming extension of the stored object; an object name of the stored object; and/or a content type of the stored object. The criteria may be statically specified (for example, by an administrator using a configuration interface) or may be dynamically determined (for example, in view of current network conditions). Furthermore, one or more wildcards may be used as criteria, to potentially match more than one stored object.

In another aspect, the present invention provides techniques for deploying objects to improve efficiency of serving large objects in network computing environments which include NAS, comprising: receiving a deployment request for a particular object; deploying the particular object on the NAS; evaluating characteristics of the particular object; creating a redirect link on one or more servers from which the particular object may be requested, if the evaluated characteristics of the particular object meet predetermined criteria; and creating an object serving link on the one or more servers otherwise. In this technique, the redirect link preferably enables returning a redirect status code to a requester of the object, and receiving the redirect status code preferably causes the requester to automatically request establishment of a subsequent connection for retrieving the particular object directly from the NAS. Contents of the redirect link may be programmatically created, or manually created.

In yet another aspect, the present invention provides techniques for efficiently serving large objects in network computing environments which include NAS, comprising: receiving a deployment request for a particular object; deploying the particular object on the NAS; creating a redirect link on one or more servers from which the particular object may be requested; creating an object serving link on the one or more servers; and delaying until run-time a decision on whether to serve the particular object directly from the NAS using the redirect link or through a selected one of the servers using the object serving link.

The present invention may also be used advantageously in methods of doing business, for example by providing network hosting services wherein the delivery of large objects operates in an improved manner. Providers of such services may offer these advantages to their customers for a competitive edge in the marketplace.

The present invention will now be described with reference to the following drawings, in which like reference numbers denote the same element throughout.

### BRIEF DESCRIPTION OF THE DRAWINGS

FIG. 1 is a diagram of a server site in which incoming content requests arrive and are serviced, according to the prior art;

FIG. 2 illustrates a typical NAS environment of the prior art;

FIG. 3 is a diagram showing placement of a Web server in a NAS system to allow configuration thereof, according to the prior art;

FIG. 4 is a block diagram which illustrates, at a high level, components of a NAS system of the prior art;

FIG. 5 illustrates a prior art NAS environment which includes multiple servers organized as a server farm;

FIG. 6 depicts the flow of messages and data between components of a typical prior art distributed computing network which uses NAS;

FIG. 7 shows samples of syntax that may be used to optimize delivery of large files, according to a preferred embodiment of the present invention;

FIG. 8 shows the flow of messages and data for delivery of large files in a distributed computing network which uses NAS, according to the present invention; and

FIGS. 9 through 12 provide flowcharts illustrating operations of a preferred embodiment of the present invention.

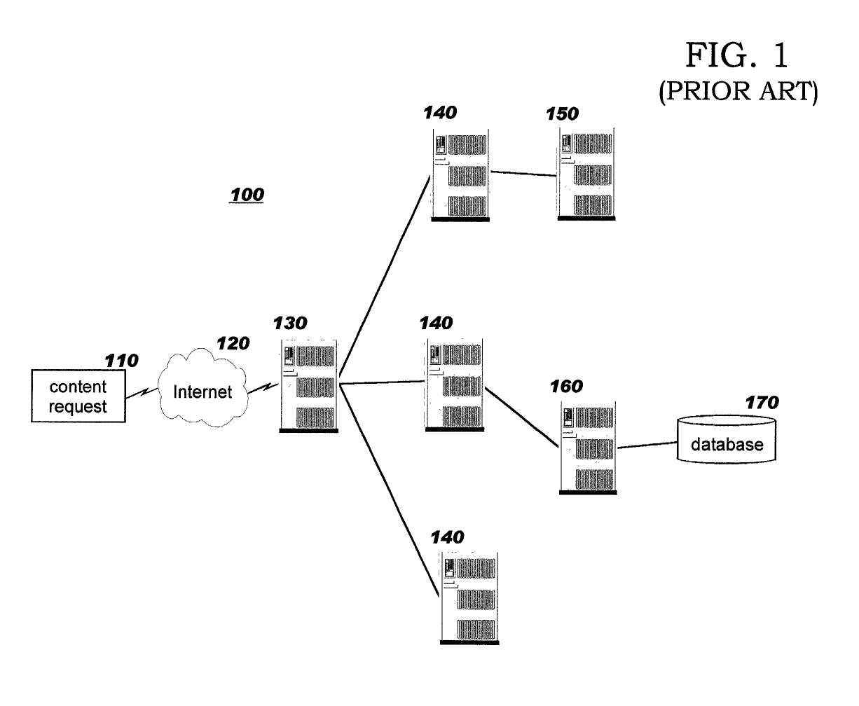

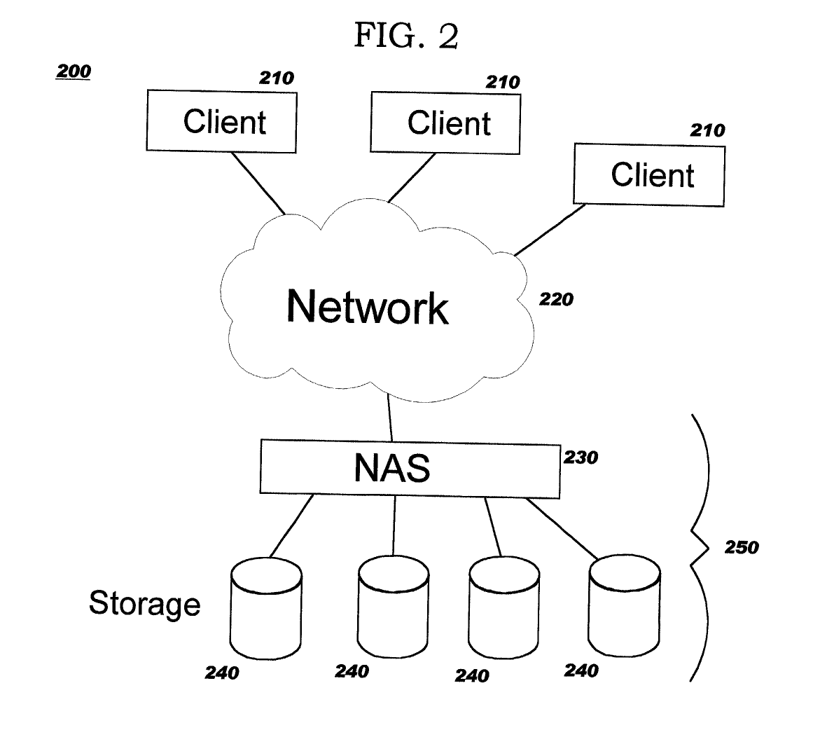

### DESCRIPTION OF PREFERRED EMBODIMENTS

The present invention provides improved techniques for serving large files in distributed computing networks which include network-attached storage. Using the techniques disclosed herein, processing load and network traffic on Web servers in the network path is reduced, allowing them to operate more efficiently and to serve more requests. Whereas in the prior art, response messages which deliver requested content are returned through the Web server which received the client's request for that content, the techniques of the present invention enable eliminating that Web server from the return path. This approach increases the Web server's efficiency, as contrasted to the prior art approach wherein the Web server functions primarily as a data conduit on the return path, simply returning a requested file in a response message which completes the protocol steps for the client's earlier request message.

While preferred embodiments are described herein with reference to NAS system, other analogous types of intelligent storage systems may be used equivalently, provided that storage system has capability for receiving and responding to HTTP messages or equivalents thereto. Such intelligent storage systems are referred to hereinafter as network-attached storage or NAS systems for ease of reference. It should also be noted that in a wireless networking environment, a protocol such as the Wireless Session Protocol (commonly referred to as “WSP”) may be used instead of HTTP. References herein to use of HTTP are intended to include analogous protocols such as WSP. (For more information on WSP, see “Wireless Application Protocol, Wireless Session Protocol Specification”, WAP-230-WSP, Jul. 5, 2001, which is available on the Internet at www.wapforum.org. This document is referred to herein as “the WSP Specification”.)

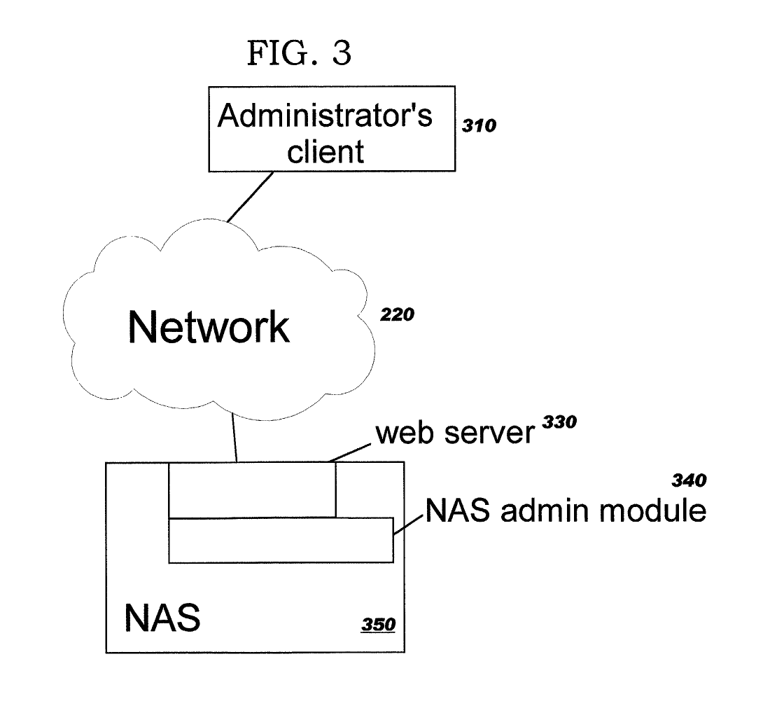

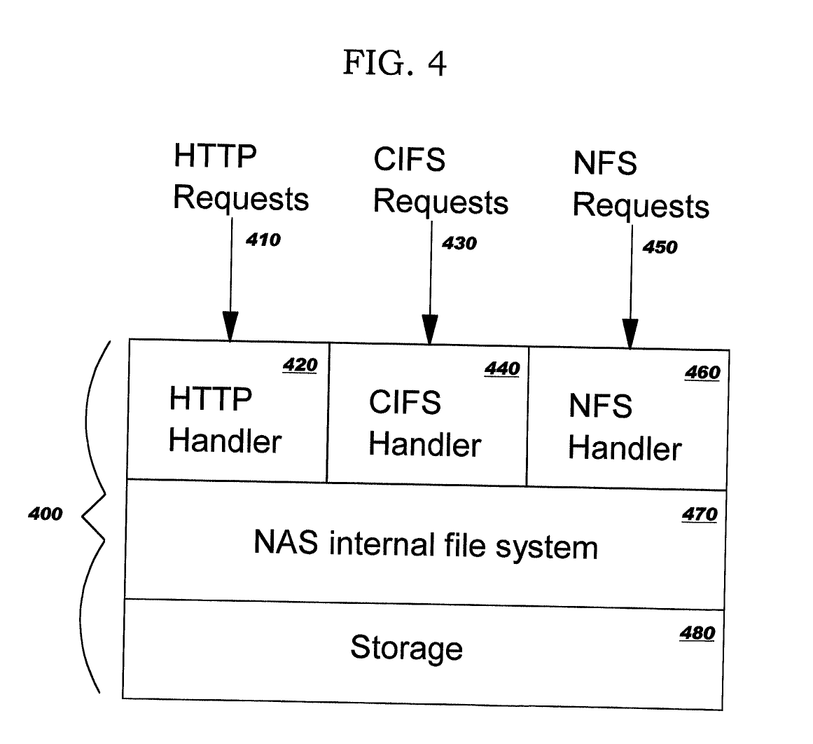

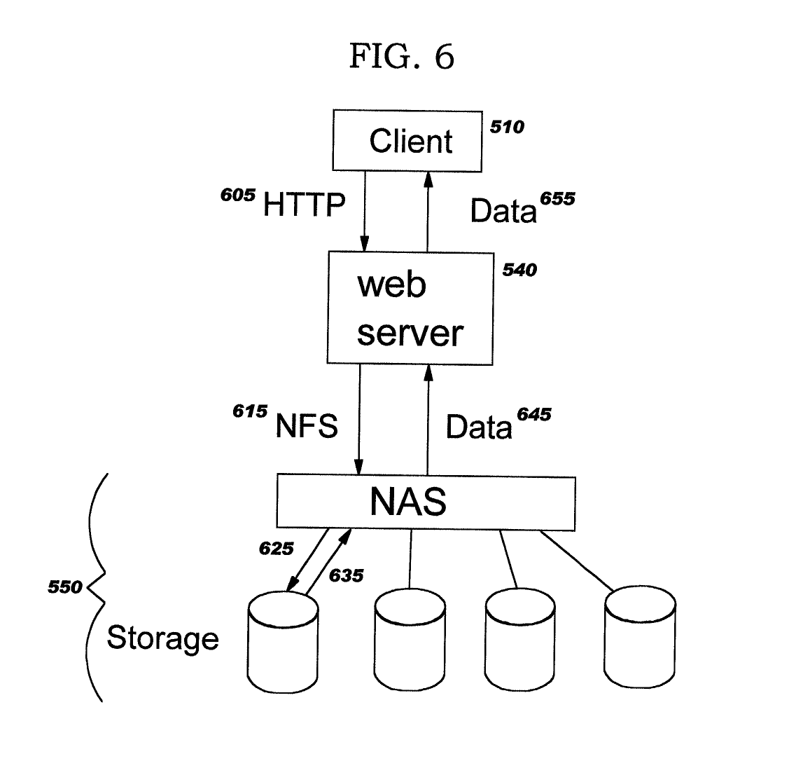

The present invention capitalizes on standard elements of HTTP and Web servers which support HTTP messages, using these elements in a novel way to improve serving of large files. In particular, existing “redirect” features of HTTP are used to dynamically create a network path between a requesting client and a NAS system on which a requested file is stored, thereby eliminating the Web server in the Web server farm (such as Web server 540 in FIG. 6). By placing a standard Web server in the NAS system, as shown in the NAS configuration scenario of FIG. 3, standard HTTP redirect support enables the present invention to selectively serve files directly to the client from the NAS. This is achieved without requiring specialized code to be installed on the NAS and without modification to the standard Web server.

HTTP redirect messages are commonly used when a Web page moves from one location to another. To enable incoming requests which use a moved Web page's now-obsolete address to continuing functioning, a Webmaster may deploy a small Web page containing a redirect indication or directive for that obsolete address, where the directive in this small Web page points a requester to a new location. When a browser (or, equivalently, other user agent) requests a Web page for which a redirect indication has been deployed, the standard functioning of the HTTP protocol causes the browser to automatically request the Web page at its new location. For example, suppose the content of a Web page which is normally accessed using the Uniform Resource Locator (“URL ”) “www.ibm.com/samplePage.html” is moved such that it is now accessible using the URL “www.ibm.com/newSamplePage.html”. Many already-stored references to the original URL might be in existence, and it is desirable to enable such references to continue functioning in a relatively transparent manner. The redirect support in HTTP allows this to happen. When a request for the original URL arrives, an HTTP response message containing a special redirect status code, along with the new URL, is returned to the requester instead of the requested content (and, importantly, instead of an error code). When the browser receives the HTTP response message, it detects the redirect status code and automatically sends another request, this time using the new URL from the HTTP response message.

Several different types of redirect indications are defined in HTTP, and all use a “3xx” format—that is, a 3-digit message status code beginning with the number 3. In HTTP 1.1, the codes are taken from the set (300, 301, 302, 303, 304, 305, 307). See Request For Comments (“RFC”) 2616 from the Internet Engineering Task Force (“IETF”), titled “Hypertext Transfer Protocol—HTTP/1.1” (June 1999), section 10.3, which is entitled “Redirection 3xx”, for a detailed description of these status codes. (This RFC is referred to hereinafter as “the HTTP Specification”.) The counterpart status codes in WSP are defined in Table 36 of the WSP Specification, and use a 0x3n format, where “n” takes the values between 0 and 7. (Note that Section 8.2.2.3, “Redirect”, of the WSP Specification states that sending a redirect protocol data unit may be used as a “crude form of load balancing at session creation time”. That is, a server might return a redirect code as a way of transferring traffic to a different server. Load balancing techniques of this type are known in the art, whereby session handoff may be performed at run-time. However, this is distinct from the approach of the present invention, which uses redirection to completely bypass the Web server for outbound traffic and not to transfer the session to a different Web server. In addition, the techniques used to determine how load should be balanced among Web servers in this prior art approach are typically based on the relative loading of the servers, whereas the techniques of the present invention are concerned with optimizing return traffic.)

In preferred embodiments of the present invention, HTTP status code 302 is used for redirect files. As defined in the HTTP Specification, status code 302 has the semantic meaning of “Found” (that is, the requested file was found, but is temporarily located at another address) and is appropriate when a file is temporarily located at a URL other than the one the client originally used for the request. Status code 302 therefore notifies the client to re-request the file from the temporary URL, but not to overwrite the original URL in its reference. In alternative embodiments, other redirect status codes may be used instead of 302, without deviating from the scope of the present invention. For example, status code 307, which has the semantic meaning of “Temporary Redirect”, is quite similar to status code 302, and may be substituted therefor in an alternative embodiment. Similarly, status code 301 (“Moved permanently”) or status code 303 (“See Other”) might be substituted for status code 302.

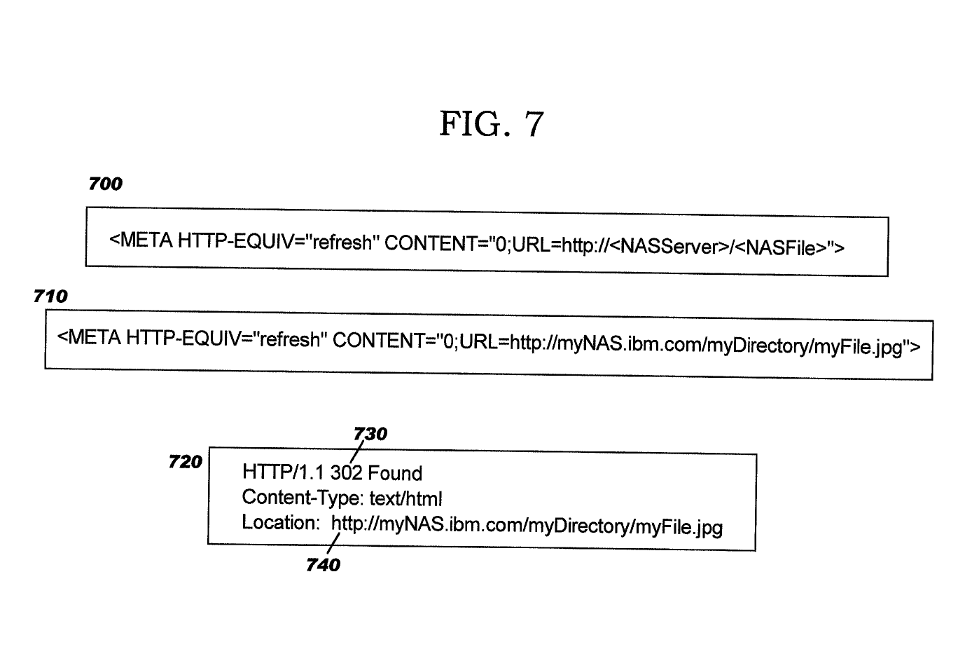

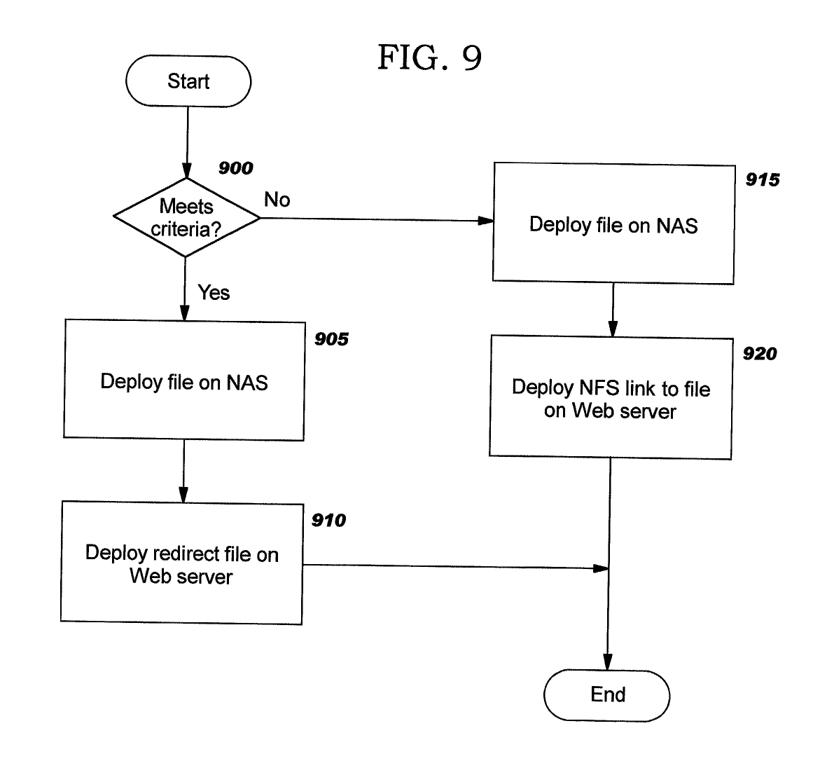

FIG. 7 illustrates samples of syntax that may be used to optimize delivery of large files, according to a preferred embodiment of the present invention. The syntax example at 700 shows the general format of a META tag that may be included in the HEAD tag of a stored Hypertext Markup Language (“HTML”) page as a redirect file (that is, a file which will cause a redirect status code to be returned to a requester). Information on the META tag can be found in Request For Comments (“RFC”) 2518 from the IETF, which is entitled “HTTP Extensions for Distributed Authoring—WEBDAV” (February 1999). In this example 700, the HTTP-EQUIV attribute is assigned a value of “refresh”, and the CONTENT attribute includes the new URL to be used in requesting the file directly from the NAS. This URL is shown as having the form “http://<NASServer>/<NASFile>”, according to preferred embodiments, where <NASServer> represents the hostname assigned to the NAS system and <NASFile> represents the file on the NAS. The syntax example at 710 shows how an actual URL might be specified using this approach. In example 710, the NAS hostname is “myNAS.ibm.com”, and the NAS file name is “myDirectory/myFilejpg”. A file containing syntax such as example 710, which is referred to herein as a “redirect file” or “redirect page”, is deployed at a Web server (as described in more detail below, with reference to the flowchart in FIG. 9), according to the present invention. A redirect file is a file that instructs the Web server (programmatically) to return a redirect status code, along with an indication of a file's location on NAS, according to the present invention. When a redirect file is created, there is preferably a straightforward association or correspondence between the name of the redirect file and the location of the “real” content stored as a file on the NAS. For example, the redirect file represented by example 710 might be created for redirecting references to “www.ibm.com/myDirectory/myFilejpg”. Thus, in this example, the hostname from the original URL has been replaced by a hostname of the NAS, and the file specification from the original URL has been re-used as the filename on the NAS. (As an alternative to this type of correspondence, any name could be used for locating the file on the NAS, as long as the redirect file containing the META tag specifies that NAS file name.)

Syntax example 720 in FIG. 7 provides an example of several pertinent fields within an HTTP response message which contains a redirect status code of 302 (see 730). Note that the Location element within the response header specifies the new URL which should be used when requesting the file from its location on the NAS (see 740).

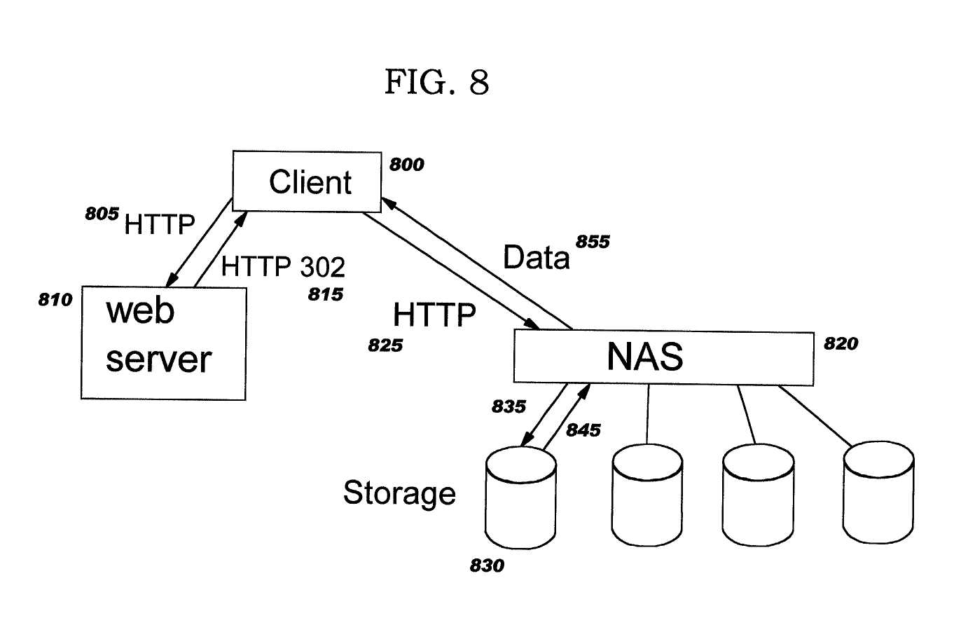

Referring now to FIG. 8, a flow of messages and data between components is shown for serving a large file according to the present invention. To eliminate sending large files through the Web server 810 on the return path to a requesting client 800, when using the present invention the Webmaster deploys a redirect file on Web server 810 instead of the actual large file, where this redirect page points to the (logical) location of the large file on the NAS 820. When serving this re-located file, the steps are as follows:

a client 800 requests a file from a Web server 810 by sending an HTTP request message 805 (or equivalent message in another protocol);

the Web server returns the contents of the redirect page (i.e. the redirect indication, as described above with reference to the syntax examples in FIG. 7) as the HTTP response message 815, instead of the actual requested file;

upon receiving the redirect page, client 800 automatically sends another HTTP request message 825, this time using the address information (i.e. the new URL) from response message 815, which causes the request message 825 to be sent to the Web server component of NAS 820 (where the large file is stored on some storage medium 830 which is controlled by NAS 820);

the Web server component of NAS 820 accesses the file directly from NAS storage, as shown at elements 835 and 845, retrieving the large file contents;

the file contents are returned from the Web server component of the NAS to the client as the data on an HTTP response message 855.

For small files, this process is expected to be sub-optimal, since it introduces an additional network hop. However, for large files (such as multimedia files, streaming audio and video, etc.), the cost of adding this additional network hop is dwarfed by the overall cost of serving the large file, and will not be noticed by a user. In addition, by eliminating this traffic through Web server 810, the enterprise deploying this technique will increase its Web server throughput.

Referring now to the flowcharts in FIGS. 9 through 12, logic is depicted which may be used to implement a preferred embodiment of the present invention. FIG. 9 provides logic which may be used when deploying files in a distributed computing network. In preferred embodiments, this logic is implemented in a programmatic solution which automatically deploys files; alternatively, file deployment may be performed manually using the logic illustrated in FIG. 9 without deviating from the scope of the present invention. For a programmatic solution, a content management or content authoring tool may be used to generate the original file content. (A commercially-available example is the Vignette family of products from Vignette Corporation. See http://www.vignette.com.) When the final page is being generated, prior art approaches typically deploy the page to a particular Web server (for example, a Web server which has been identified using a configuration interface or selection capability of the content management tool) or, alternatively, to a location on the NAS when the enterprise uses a NAS system. However, according to the present invention, one or more criteria may be specified to determine the optimal way to deploy the content, as will now be described.

In preferred embodiments, the criteria for serving a file directly from NAS (that is, using redirection), instead of through a Web server in the Web server farm, may include (by way of example): (1) the file size exceeds some threshold; (2) the file has a particular extension; (3) the file has a particular name; or (4) the file is of a particular content type. These types of criteria may be used singly or in combination, and more than one of each type of criteria may be used in making the redirection determination as well. For example, a file might be selected for redirection if (1) it has a content type of “image/gif” or “image/jpg” and (2) its size is greater than 500 kilobytes. Preferably, the value to be used for all criteria is selected such that the benefit of redirection outweighs the cost of the additional network round-trip. (As will be obvious, the faster the network, the less negative impact will be felt from the extra round-trip.)

When file size is used as a criterion, the threshold size value may be specified in several ways, including explicitly specifying the value using a manual approach (such as by a systems administrator who uses a configuration interface to provide a value), hard-coding a particular value into code which performs the redirection determination, or algorithmically determining a suitable value. While file size may be used advantageously in many cases for making a static deployment decision and a static redirection determination (for example, files greater than a certain size are always redirected), there may be cases where a dynamic decision is beneficial. As an example of the latter case, a dynamic decision may be made by observing various types of network conditions such as traffic conditions in the network, current load on the server at which a request arrives, and so forth. One way in which this may be implemented is to consult rules from a rules base, where those rules specify semantics such as “if detected (or perhaps configured) external network speed is less than X, then redirect all files of size greater than Y”, where values for X and Y may be selected by a network administrator (e.g. in an attempt to tune the network performance). Support for dynamic decisions of this type is an optional aspect of the present invention.

When file extension is used as a criterion, the extensions of interest are preferably specified as a list (e.g. using a configuration interface), or may alternatively be hard-coded in an implementation. Or, rules from a rules base might be used to dynamically determine the extensions, in a similar manner to that described above for file size. For example, a rule might specify “if detected network speed is less than X, then redirect all files having file extensions of mpg” or “if current server load is greater than Z, then redirect all files having a content type of image/tif”. Furthermore, wildcard values might be used to identify the file extensions of interest. For example, “*pg” or “.*pg” might be used to indicate that MPEG files as well as JPEG files (i.e. files having extensions of ‘.mpg’ and ‘.jpg’) should be redirected.

File name and content type may each be used as a criterion, and the file names and content types of interest may be specified in a similar manner to that which has been described for file extensions.

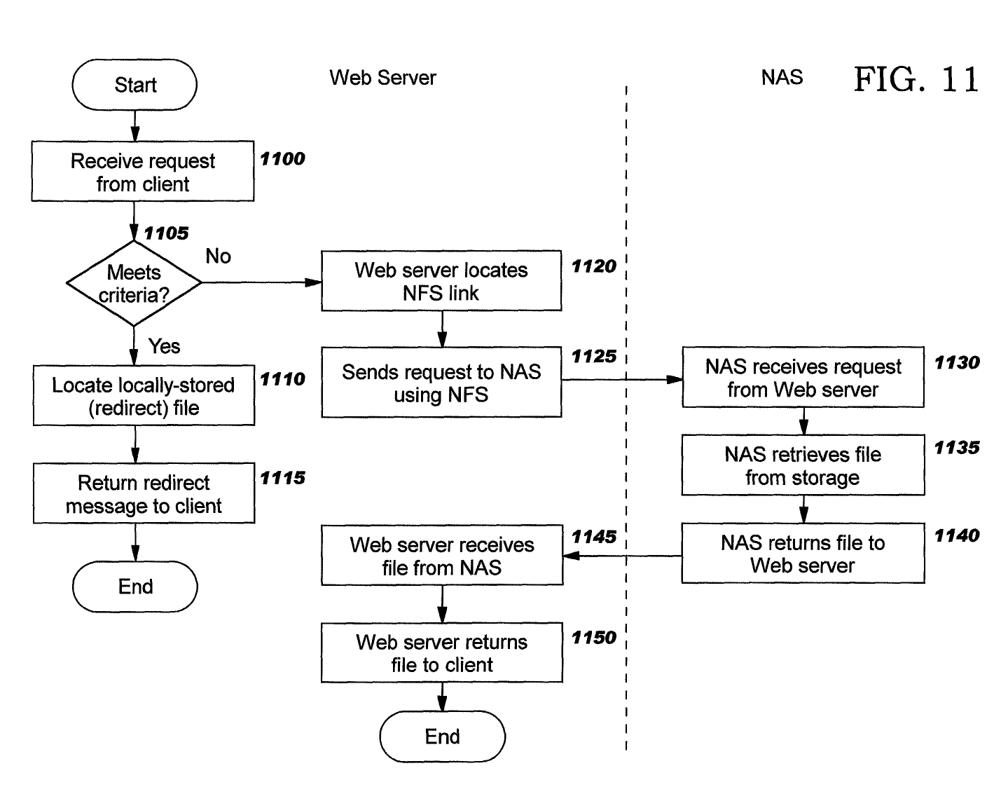

It should be noted that existing Web servers typically include a feature to allow special handling of files having certain parameters, such as those files having certain extensions. This support is leveraged by the present invention (e.g. at Block 1105 of FIG. 11). For example, many Web servers provide a configuration interface capability for identifying content handlers that should handle particular content types at run-tine.

Returning now to FIG. 9, when a page is ready for deployment, a test is made (Block 900) to see if the specified criteria are met for deploying this page using redirection. If so, then processing continues at Block 905 where the file is deployed on the NAS, and in Block 910, a redirect file is deployed on the Web server. In preferred embodiments, the redirect file is also deployed on the other Web servers in the server farm (using standard techniques of a content management tool to transmit the files to multiple locations), enabling any server which subsequently receives a request for this file to automatically send a redirect status code according the present invention. As stated with reference to FIG. 7, a correspondence is preferably maintained between the URLs on the Web server and URLs on the NAS. Thus, files indicated by syntax such as “http://<web server hostname>/file” are preferably stored at a location “http://<NAS host name>/file” on the NAS. In preferred embodiments, this correspondence is used to enable programmatic generation of the contents of the redirect file. (In alternative embodiments, redirect file contents can be manually specified if desired, without deviating from the scope of the present invention.)

When the criteria for redirection are not met (i.e. a negative result in Block 900), the file is deployed as a standard NAS file (Block 915), and an NFS link to that file is preferably deployed on the Web server (Block 920). The NFS link is a correspondence used to locate a file using an NFS request message after having received an HTTP request, and is created using prior art techniques; see flows 605 and 615 of FIG. 6.

When the optional support for dynamic decisions about redirection is provided, then the processing of Blocks 905, 910, 915, and 920 may be performed for each file meeting the redirection criteria. That is, the files may be deployed both on the NAS for retrieval through the Web servers in the server farm, as in the prior art, and also using a redirect file deployed on the Web servers. This dual-deployment approach optimizes handling of redirection criteria which include dynamic aspects, so that the file will be found in either manner, irrespective of the runtime dynamic decision.

It will be obvious to one of skill in the art how the logic of FIG. 9 may be added to an existing content management system; alternatively, a specialized deployment tool may be created to perform this process if desired.

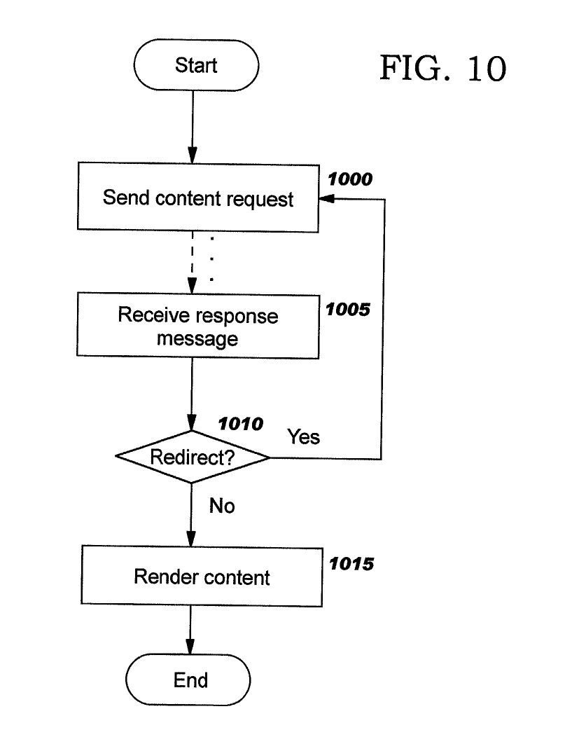

FIG. 10 illustrates logic of processing which occurs at a client during operation of the present invention. It should be noted that this processing uses prior art support for HTTP (and only the pertinent subset is illustrated in the figure), and therefore no specialized code is required to be added to client devices. At Block 1000, the client sends a request for content into the network. After some amount of time passes, the client receives a response message (Block 1005). A test is then made to determine whether this response message contains a redirect status code. If so, then this redirect code causes control to effectively return to Block 1000, where the new URL from the response message is used to re-send the content request. (According to the present invention, this second content request will be directed to the NAS, whereas the original request was received by a Web server in the server farm.) If not, then the requested content has been received, and it is typically rendered (Block 1015).

FIG. 11 illustrates processing at a Web server in the server farm (on the left) and at a NAS (on the right), including the flow of messages and data between these components. At Block 1100, the Web server receives a content request in an HTTP request message from a client (responsive to Block 1000 of FIG. 10, for example). The Web server then checks to see if this request is for a file meeting the redirection criteria (Block 1105). If so, then the locally-stored redirect file is retrieved (Block 1110) and sent to the client (Block 1115) using a redirect status code on the HTTP response message. (See 720 of FIG. 7 for an example.) The processing of this client request by the Web server is then complete, and a subsequent connection will be automatically requested by the client directly to the NAS, thereby bypassing the Web server in the server farm for delivery of the file.

If the optional support for dynamic decisions about redirection is implemented, then the test at Block 1105 further comprises evaluating the dynamically-determined criteria to see if they are met.

When the client request does not meet the criteria for redirection, the test in Block 1105 has a negative result, and processing continues at Block 1120 to serve the file through the Web server in the server farm. The Web server locates the NFS link for the requested file, using the information stored during file deployment. (See Block 920 of FIG. 9.) The Web server then sends a request to the NAS for this file, using a file access protocol such as NFS, at Block 1125. The NAS receives this request (Block 1130), and retrieves the requested file from its storage (Block 1135). The file is then returned to the Web server (Block 1140), as the response to the message received at Block 1130. When the Web server receives the response from the NAS (Block 1145), it returns the data to the client (Block 1150) using an HTTP response message, where this is the protocol response to the request message received at Block 1100.

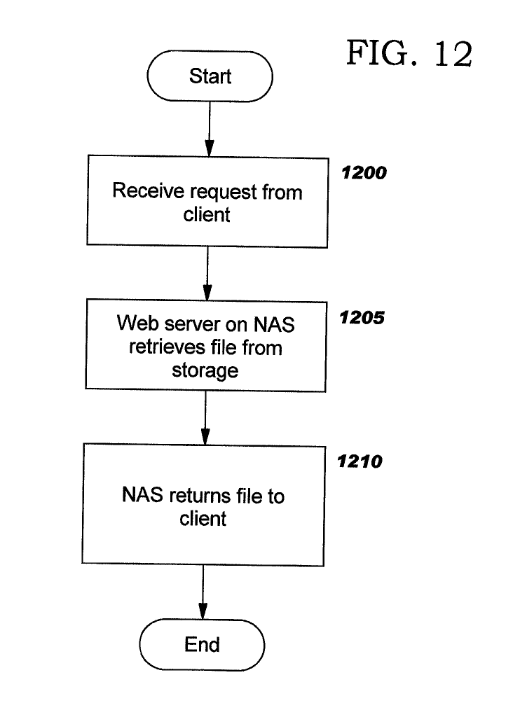

As shown in FIG. 12, the processing that takes place in the Web server on the NAS comprises receiving the client's redirected HTTP request message (Block 1200), which has bypassed the Web servers in the server farm; retrieving the requested file from storage (Block 1205); and returning the file to the client (Block 1210) using an HTTP response message. (As stated with reference to FIG. 7, the redirect message sent to the client according to Block 1110 and 1115 of FIG. 11 results in the client having a URL which directly identifies a location on the NAS; this location is used in the retrieval operation of Block 1205.)

Note that in some enterprises, content requests might always (or nearly always) be for large files. An example of this situation is an enterprise that provides music for downloading, or perhaps which supplies some type of video feed. In such cases, it might be desirable to always use the redirection technique of the present invention. Thus, it is not strictly necessary to implement the testing specified by Block 1105 of FIG. 11; instead, all requests might simply be routed to the processing of Block 1110. (Similarly, the testing specified by Block 900 of FIG. 9 might be omitted, with all deployment using the approach shown in Blocks 905 and 910.)

Many Web pages include content from more than one file. For example, the HTML code for a page might include several references to other objects such as images, sound files, and so forth. As is known in the art, separate requests are transmitted by the client to the Web server for each such object. Any of these requests may be served using the techniques of the present invention, provided that the redirection criteria are met.

As has been demonstrated, the present invention provides advantageous techniques for improving serving of large files in distributed computing environments which include network-attached storage or equivalents thereto. It is anticipated that distributed computing environments of the future will continue to use server farms connected to a NAS system, and thus the present invention enables the servers in the server farms to operate with increased efficiency and higher throughput, and thereby enables overall response time to clients to be improved (in spite of the extra network hop added by the techniques of the present invention). The disclosed techniques leverage existing features of HTTP (or, alternatively, WSP) and of Web server implementations to achieve performance improvements in a novel way, and thereby greatly facilitate introduction of the present invention into existing networking environments.

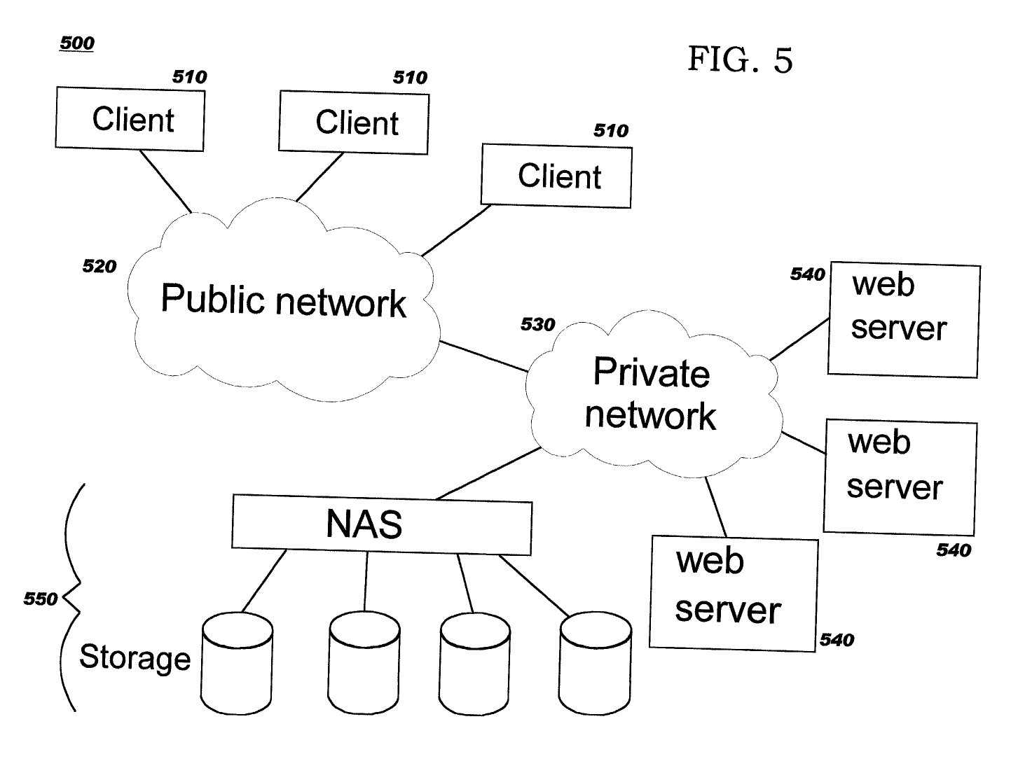

Content distribution systems are known in the art which attempt to speed delivery of content to requesters by deploying the content at multiple locations, or at locations which are geographically near the expected requesters, and so forth. An example is the Akamai EdgeSuite^{SM} service from Akamai Technologies, Inc. (“EdgeSuite” is a service mark of Akamai Technologies, Inc.) Content distributions systems may use cache sites in deploying content, and these cache sites may closely resemble the content sites which have been described herein—such as that depicted in FIG. 5, for example—having Web server farms, NAS systems, etc. In such cases, the techniques of the present invention may be used advantageously for serving the content from sites of this type more efficiently.

The disclosed techniques may also be used to implement improved methods of doing business. For example, network hosting services may implement the techniques of the present invention to deliver large files in an improved manner. Providers of such services may offer these advantages to their customers for a competitive edge in the marketplace.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While the preferred embodiments of the present invention have been described, additional variations and modifications in those embodiments may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method of efficiently serving objects in a computing network, comprising steps of:
receiving a request for an object stored on network-attached storage (“NAS”); and
evaluating predetermined criteria to see if the stored object should be served from the NAS through a recipient of the received request.

2. The method according to claim 1, wherein the evaluating step further comprises steps of:
serving the stored object through the recipient of the received request when the selected criteria are not met; and
informing a sender of the received request that a subsequent connection should be established for serving the stored object when the selected criteria are met.

3. The method according to claim 2, wherein the subsequent connection bypasses the recipient of the received request.

4. The method according to claim 2, wherein the informing step uses a redirect code of an existing protocol.

5. The method according to claim 4, wherein the existing protocol is Hypertext Transfer Protocol.

6. The method according to claim 4, wherein the existing protocol is Wireless Session Protocol.

7. The method according to claim 4, wherein receipt of the redirect code by the sender of the received request automatically causes the sender to request establishment of the subsequent connection.

8. The method according to claim 1, wherein the predetermined criteria include a size of the stored object.

9. The method according to claim 8, wherein evaluating the predetermined criteria comprises comparing the size of the stored object to a statically-specified number.

10. The method according to claim 9, wherein the statically-specified number is specified by an administrator using a configuration interface.

11. The method according to claim 8, wherein evaluating the predetermined criteria comprises comparing the size of the stored object to a dynamically-determined number.

12. The method according to claim 11, wherein the dynamically-determined number is determined in view of current network conditions.

13. The method according to claim 1, wherein the predetermined criteria include a naming extension of the stored object.

14. The method according to claim 13, wherein evaluating the predetermined criteria comprises determining whether the naming extension matches an element in a statically-specified set of naming extensions.

15. The method according to claim 14, wherein the statically-specified set of naming extensions is specified by an administrator using a configuration interface.

16. The method according to claim 13, wherein evaluating the predetermined criteria comprises determining whether the naming extension matches an element in a set of dynamically-determined set of naming extensions.

17. The method according to claim 16, wherein the dynamically-determined set of naming extensions is determined in view of current network conditions.

18. The method according to claim 1, wherein the predetermined criteria include a name of the stored object.

19. The method according to claim 18, wherein evaluating the predetermined criteria comprises determining whether the object name matches an element in a statically-specified set of object names.

20. The method according to claim 19, wherein the statically-specified set of object names is specified by an administrator using a configuration interface.

21. The method according to claim 18, wherein evaluating the predetermined criteria comprises determining whether the object name matches an element in a set of dynamically-determined set of object names.

22. The method according to claim 21, wherein the dynamically-determined set of object names is determined in view of current network conditions.

23. The method according to claim 1, wherein the predetermined criteria include a content type of the stored object.

24. The method according to claim 23, wherein evaluating the predetermined criteria comprises determining whether the content type matches an element in a statically-specified set of content types.

25. The method according to claim 24, wherein the statically-specified set of content types is specified by an administrator using a configuration interface.

26. The method according to claim 23, wherein evaluating the predetermined criteria comprises determining whether the content type matches an element in a set of dynamically-determined set of content types.

27. The method according to claim 26, wherein the dynamically-determined set of content types is determined in view of current network conditions.

28. The method according to claim 1, wherein the predetermined criteria includes use of one or more wildcards which may operate to match more than one stored object.

29. A method of deploying objects to improve efficiency of serving large objects in network computing environments which include network-attached storage (“NAS”), comprising steps of:
receiving a deployment request for a particular object;
deploying the particular object on the NAS;
evaluating characteristics of the particular object;
creating a redirect link on one or more servers from which the particular object may be requested, if the evaluated characteristics of the particular object meet predetermined criteria; and
creating an object serving link on the one or more servers if the evaluated characteristics of the particular object do not meet the predetermined criteria.

30. The method according to claim 29, wherein the redirect link enables returning a redirect status code to a requester of the object.

31. The method according to claim 30, wherein receiving the redirect status code causes the requester of the object to automatically request establishment of a subsequent connection for retrieving the particular object directly from the NAS.

32. The method according to claim 30, wherein contents of the redirect link are programmatically created.

33. The method according to claim 30, wherein contents of the redirect link are manually created.

34. A method of efficiently serving large objects in network computing environments which include network-attached storage (“NAS”), comprising steps of:
receiving a deployment request for a particular object;
deploying the particular object on the NAS;
creating a redirect link on one or more servers from which the particular object may be requested;
creating an object serving link on the one or more servers; and
delaying until run-time a decision on whether to serve the particular object directly from the NAS using the redirect link or through a selected one of the servers using the object serving link.

35. A system for efficiently serving objects in a computing network, comprising:
means for receiving a request for an object stored on network-attached storage (“NAS”); and
means for evaluating predetermined criteria to see if the stored object should be served from the NAS through a recipient of the received request.

36. The system according to claim 35, wherein the means for evaluating further comprises:
means for serving the stored object through the recipient of the received request when the selected criteria are not met; and
means for informing a sender of the received request that a subsequent connection should be established for serving the stored object when the selected criteria are met.

37. The system according to claim 36, wherein the subsequent connection bypasses the recipient of the received request.

38. The system according to claim 36, wherein the means for informing uses a redirect code of an existing protocol, and wherein receipt of the redirect code by the sender of the received request automatically causes the sender to request establishment of the subsequent connection.

39. A system for deploying objects to improve efficiency of serving large objects in network computing environments which include network-attached storage (“NAS”), comprising:
means for receiving a deployment request for a particular object;
means for deploying the particular object on the NAS;
means for evaluating characteristics of the particular object;
means for creating a redirect link on one or more servers from which the particular object may be requested, if the evaluated characteristics of the particular object meet predetermined criteria; and
means for creating an object serving link on the one or more servers if the evaluated characteristics of the particular object do not meet the predetermined criteria.

40. A computer program product for efficiently serving objects in a computing network, the computer program product embodied on one or more computer-readable media and comprising:
computer readable program code means for receiving a request for an object stored on network-attached storage (“NAS”); and
computer readable program code means for evaluating predetermined criteria to see if the stored object should be served from the NAS through a recipient of the received request.

41. The computer program product according to claim 40, wherein the computer readable program code means for evaluating further comprises:
computer readable program code means for serving the stored object through the recipient of the received request when the selected criteria are not met; and
computer readable program code means for informing a sender of the received request that a subsequent connection should be established for serving the stored object when the selected criteria are met.

42. The computer program product according to claim 41, wherein the subsequent connection bypasses the recipient of the received request.

43. The computer program product according to claim 41, wherein the computer readable program code means for informing uses a redirect code of an existing protocol, and wherein receipt of the redirect code by the sender of the received request automatically causes the sender to request establishment of the subsequent connection.

44. A computer program product for efficiently serving large objects in network computing environments which include network-attached storage (“NAS”), the computer program product embodied on one or more computer-readable media and comprising:
computer readable program code means for receiving a deployment request for a particular object;
computer readable program code means for deploying the particular object on the NAS;
computer readable program code means for creating a redirect link on one or more servers from which the particular object may be requested;
computer readable program code means for creating an object serving link on the one or more servers; and
computer readable program code means for delaying until run-time a decision on whether to serve the particular object directly from the NAS using the redirect link or through a selected one of the servers using the object serving link.
